(19) United States
(12) Patent Application Publication
(10) Pub. No.: US 2007/0016959 A1
(43) Pub. Date: Jan. 18, 2007

(54) Information processing device and information processing system

(76) Inventors: Yuichi Ikeda, Osaka (JP); Takuji Kioka, Osaka (JP)

Correspondence Address: MCDERMOTT WILL & EMERY LLP, 600 13TH STREET, N.W., WASHINGTON, DC, 20005-3096, US

(21) Appl. No.: 11/486,000

(22) Filed: Jul. 14, 2006

(30) Foreign Application Priority Data
Jul. 15, 2005 (JP) 2005-206839

(51) Int. Cl. H04L 9/32

(52) U.S. Cl. 726/27; 713/168

(57) ABSTRACT

An information-processing device for communicating with an external communication target device according to the present invention comprises an access permission request signal generator for generating an access permission request signal which requests the communication target device to permit an access and outputting the generated signal to the communication target device, an access permission/non-permission signal discriminator for discriminating an access permission/non-permission signal outputted by the communication target device which received the access permission request signal and generating an access prohibition signal when the access permission/non-permission signal shows the non-permission of the access, and a communication controller for restricting at least a part of the communication in response to the generation of the access prohibition signal.

### BACKGROUND OF THE INVENTION

1. Field of the Invention

The present invention relates to an information-processing device and an information processing system in which authentication based on an access permission request signal is required when data is accessed, more specifically to a technology for prohibiting the data access when the authentication is failed.

2. Description of the Related Art

When a debugger accesses a semiconductor chip including a program and data which demand an advanced security, the debugger, first, issues an access permission request signal including an authentication code to the semiconductor chip. The semiconductor chip permits communication of various data between itself and the debugger only when the authentication code is legitimate and the access is thereby permitted.

However, it is generally deemed that a debugger used by a third party who does not know the authentication code can finally reach the program or data to be desirably protected if he/she repeatedly accesses the semiconductor chip while changing the authentication code. There is a measure to deal with such an unauthorized access as recited in No. 2002-341956 of the Japanese Patent Literature, wherein an input and an output to the semiconductor chip is invalidated so that any access thereafter is prohibited when the authentication code is collated in the semiconductor chip and a result of the collation indicates the unauthorized access.

Explanation is given below wherein the unauthorized is considered to be the unfair access to a communication target device by an information-processing device under the presumption that the debugger is the information-processing device and the semiconductor chip is the communication target device.

There is disadvantage as follows even if the foregoing measure is taken. Namely, an access made to an arbitrary communication target device (semiconductor chip) by an arbitrary information-processing device (debugger or the like) may be invalidated, however, the authentication code can be issued to another communication target device by the same information-processing device.

Even if the security mechanism is thus equipped on the communication-target-device side alone, if a plurality of communication target devices is prepared and the information-processing device then repeatedly issues the authentication code to the communication target devices one by one, even the unauthorized access made by a single information-processing device may succeed in violating the security in any of the communication target devices.

### SUMMARY OF THE INVENTION

Therefore, a main object of the present invention is to provide an information-processing device, such as a debugger, whose security performance is improved through prevention of an unauthorized access possibly made in such a manner that a third party, who is not given a legitimate right for access and does not know an authentication code, repeatedly issues the authentication code alternately to a plurality of communication target devices, such as a semiconductor chip or the like, in which a program, data and the like to be desirably protected are embedded.

In order to achieve the foregoing object, an information-processing device for communicating with an external communication target device according to the present invention comprises:

an access permission request signal generator for generating an access permission request signal which requests the communication target device to permit an access and outputting the generated signal to the communication target device;

an access permission/non-permission signal discriminator for discriminating an access permission/non-permission signal outputted by the communication target device which received the access permission request signal and generating an access prohibition signal when the access permission/non-permission signal shows the non-permission of the access; and

a communication controller for restricting at least a part of the communication in response to the generation of the access prohibition signal.

In the foregoing constitution, the access permission request signal generated by the access permission request signal generator is transmitted to the communication target device (semiconductor chip or the like). The communication target device checks the access permission request signal (for example, an authentication code included therein), and transmits the access permission/non-permission signal indicating the permission of the access to the information-processing device when the checked signal indicates an authorized access. When the access permission request signal indicates an unauthorized access, on the contrary, the communication target device transmits the access permission/non-permission signal indicating the access non-permission to the information-processing device. The information-processing device which received the access permission/non-permission signal discriminates the access permission/non-permission signal in the access permission/non-permission signal discriminator, and outputs the access prohibition signal to the communication controller when a result of the discrimination indicates the non-permission of the access. The communication controller thereby restricts its own communication function for the communication target device.

As a preferable mode of the foregoing constitution, it is preferable that the communication controller controls outputs of a group of first communication signals outputted by the information-processing device to the communication target device including the access permission request signal, and the communication controller blocks at least a part of the outputs of the group of first communication signals in response to the generation of the access prohibition signal.

According to the foregoing mode, the communication is restricted in such a manner that at least a part of the outputs of the group of first communication signals are blocked on the output side.

As another preferable mode of the foregoing constitution, the communication controller controls inputs of a group of second communication signals inputted by the communication target device to the information-processing device including the access permission/non-permission signal, and the communication controller blocks at least a part of the inputs of the group of second communication signals in response to the generation of the access prohibition signal.

According to the foregoing mode, the communication is restricted in such a manner that at least a part of the inputs of the group of second communication signals are blocked on the input side.

As still another preferable mode of the foregoing constitution, the communication controller controls the outputs of the group of first communication signals from the information-processing device including the access permission request signal, and also controls the inputs of the group of second communication signals to the information-processing device including the access permission/non-permission signal, and the communication controller blocks at least a part of the outputs of the group of first communication signals, and also blocks at least a part of the inputs of the group of second communication signals in response to the generation of the access prohibition signal.

In the foregoing mode, the communication is restricted in such a manner that at least a part of the outputs of the group of first communication signals are blocked on the output side, and at least a part of the inputs of the group of second communication signals are blocked on the input side.

As described, according to the present invention, the unauthorized access made to the communication target device by the third party who does not know the authentication code using the information-processing device can be prohibited at a first trial, the unauthorized access made in such a manner that the authentication code is repeatedly issued to the different communication target devices one by one can be can be effectively prevented. As a result, a security performance of the communication target device including data whose contents are desired to protect can be improved.

The access permission/non-permission signal discriminator preferably comprises a register for retaining a value of the access permission/non-permission signal. By doing so, the communication can be continuously restricted even if the information-processing device is in a disconnected state to the communication target device.

As well, it is preferable that the information-processing device further comprises a retainer for permanently retaining the access prohibition signal when the access permission/non-permission signal discriminator generates the access prohibition signal and also maintaining the output of the access prohibition signal. By doing so, when the unauthorized access is made only once, the communication function of the information-processing device is immediately restricted. Further, the communication function thereafter keeps the restricted state permanently so that the information-processing device itself cannot be used. As a result, the unauthorized access can be unfailingly prevented.

The information-processing device preferably further comprises a random number generator for generating a random signal wherein the communication controller outputs the random signal generated by the random number generator from the information-processing device as the group of first communication signals in place of the group of first communication signals in response to the generation of the access prohibition signal.

By doing so, as the signal outputted to the information-processing device is the random signal, it is made impossible to perform any intended access and thereby the unauthorized access is prevented. Further, the output signal that is variable makes it difficult to identify a cause of a failure of the communication function, which further improves the security performance.

In addition, it is preferable that the information-processing device further comprises the random number generator for generating the random signal, wherein the communication controller inputs the random signal generated by the random number generator to the information-processing device as the group of second communication signals in place of the group of second communication signals in response to the generation of the access prohibition signal.

By doing so, as the signal inputted to the information-processing device is the random signal, it is made impossible to conduct any intended access and thereby the unauthorized access is prevented. Further, the input signal that is variable makes it difficult to identify the cause of the failure of the communication function, which further improves the security performance.

The information-processing device preferably further comprises the random number generator for generating the random signal, wherein the communication controller outputs the random signal generated by the random number generator from the information-processing device as the group of first communication signals in place of the group of first communication signals, and also inputs the random signal generated by the random number generator to the information-processing device as the group of second communication signals in place of the group of second communication signals in response to the generation of the access prohibition signal.

By doing so, the input and output signals are both the random signals when the unauthorized access is made, it is made further difficult to identify the cause of the failure of the communication function. As a result, the security performance can be improved to a large extent.

The present invention can be developed as follows as an information-processing system. An information processing system according to the present invention comprises the information-processing device and the communication target device described earlier, wherein the communication target device outputs the resulting signal to the information-processing device, when the access permission request signal inputted from the information-processing device is judged to be legitimate, and makes the access permission/non-permission signal to be in a state of access permission and outputs it to the information-processing device, while the communication target device makes the access permission/non-permission signal to be in a state of access prohibition and outputs it to the information-processing device, when the access permission request signal is judged to be illegitimate.

According to the present invention, the unauthorized access can be surely prohibited at a first trial by restricting the communication function of the information-processing device (preferably made dysfunctional) even if the third party who does not know the authentication code makes the unauthorized access to the communication target device using the information-processing device. Thereby, the unauthorized access made in such a manner that the authentication code is repeatedly issued to the different communication target devices one by one can be effectively prevented. As a result, the security performance of the communication target device including data whose contents are desired to protect can be improved.

The information-processing device according to the present invention is useful as a technology for reliably preventing an unauthorized access in a debugger or the like, for accessing a communication target device, such as a semiconductor chip, including a secured program or data for which an advanced security performance is demanded.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating a schematic constitution of an information-processing device according to a preferred embodiment 1 of the present invention.

FIG. 2 is a block diagram illustrating a detailed constitution of the information-processing device according to the preferred embodiment 1.

FIG. 3 shows a constitution of a data retaining circuit of the information-processing device according to the preferred embodiment 1.

FIG. 4 shows a schematic constitution of a selector of the information-processing device according to the preferred embodiment 1.

FIG. 5 is a timing chart of an operation of the information-processing device according to the preferred embodiment 1.

FIG. 6 is a block diagram illustrating a schematic constitution of an information-processing device according to a modified embodiment 1 of the preferred embodiment 1.

FIG. 7 is a block diagram illustrating a schematic constitution of an information-processing device according to a modified embodiment 2 of the preferred embodiment 1.

FIG. 8 is a block diagram illustrating a schematic constitution of an information-processing device according to a preferred embodiment 2 of the present invention.

FIG. 9 is a block diagram illustrating a detailed constitution of the information-processing device according to the preferred embodiment 2.

FIG. 10 shows a constitution of a data retaining circuit of the information-processing device according to the preferred embodiment 2.

FIG. 11 is a timing chart of operations of a pulse generator and a fuse circuit of the information-processing device according to the preferred embodiment 2.

FIG. 12 is a block diagram illustrating a schematic constitution of an information-processing device according to a modified embodiment 1 of the preferred embodiment 2.

FIG. 13 is a block diagram illustrating a schematic constitution of an information-processing device according to a modified embodiment 2 of the preferred embodiment 2.

FIG. 14 is a block diagram illustrating a schematic constitution of an information-processing device according to a preferred embodiment 3 of the present invention.

FIG. 15 is a block diagram illustrating a detailed constitution of the information-processing device according to the preferred embodiment 3.

FIG. 16 shows a schematic constitution of a selector of the information-processing device according to the preferred embodiment 3.

FIG. 17 is a block diagram illustrating a schematic constitution of an information-processing device according to a modified embodiment 1 of the preferred embodiment 3.

FIG. 18 is a block diagram illustrating a schematic constitution of an information-processing device according to a modified embodiment 2 of the preferred embodiment 3.

### DETAILED DESCRIPTION OF THE INVENTION

Hereinafter, preferred embodiments of an information-processing device and an information-processing system according to the present invention are described in detail referring to the drawings.

### Preferred Embodiment 1

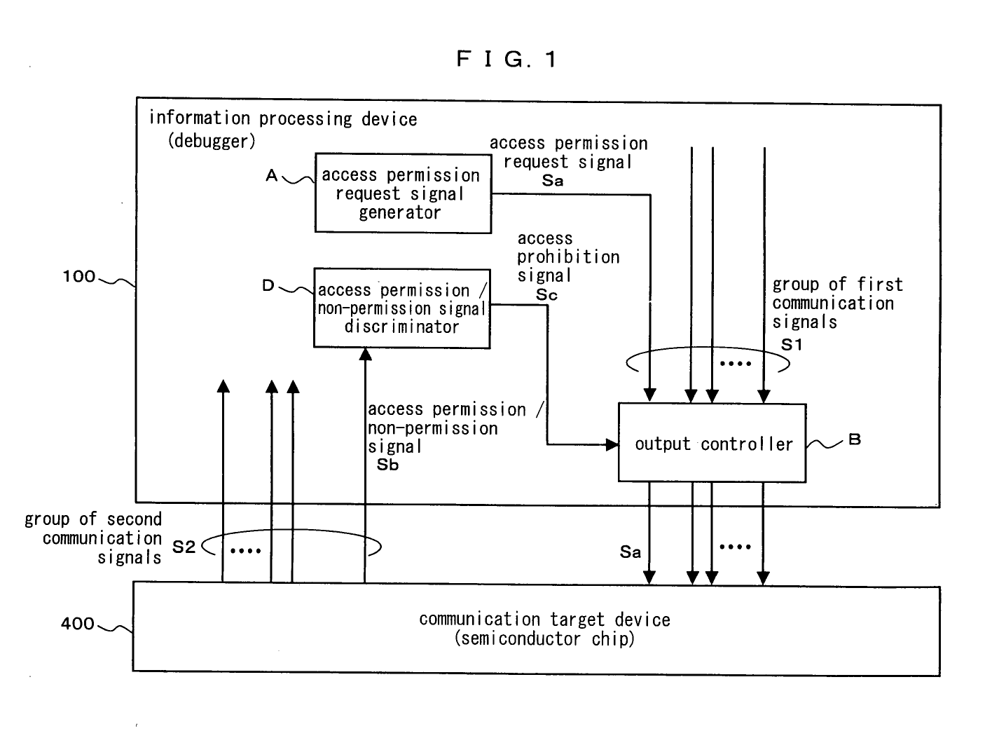

FIG. 1 is a block diagram illustrating a schematic constitution of an according to a preferred embodiment 1 of the present invention. In the present preferred embodiment, a communication target device 400 is a semiconductor chip, and an information-processing device 100 is a debugger, more specifically has a function for debugging the communication target device 400.

In FIG. 1, a reference symbol A denotes an access permission request signal generator for generating an access permission request signal Sa. The access permission request signal Sa is a signal that requests the communication target device 400 to permit an access. A reference symbol B denotes an output controller for controlling outputs of a group of first communication signals S1 including the access permission request signal Sa. The group of first communication signals S1 is a collective term for the signals outputted by the information-processing device 100 to the communication target device 400. The output controller B blocks any or all of the outputs of the group of first communication signals S1 when an access prohibition signal Sc is inputted thereto. A reference symbol D denotes an access permission non-permission signal discriminator. The access permission/non-permission signal discriminator D discriminates an access permission/non-permission signal Sb included in a group of second communication signals S2 inputted from the communication target device 400, and outputs the access prohibition signal Sc to the output controller B when a result of the discrimination is to be the non-permission of the access.

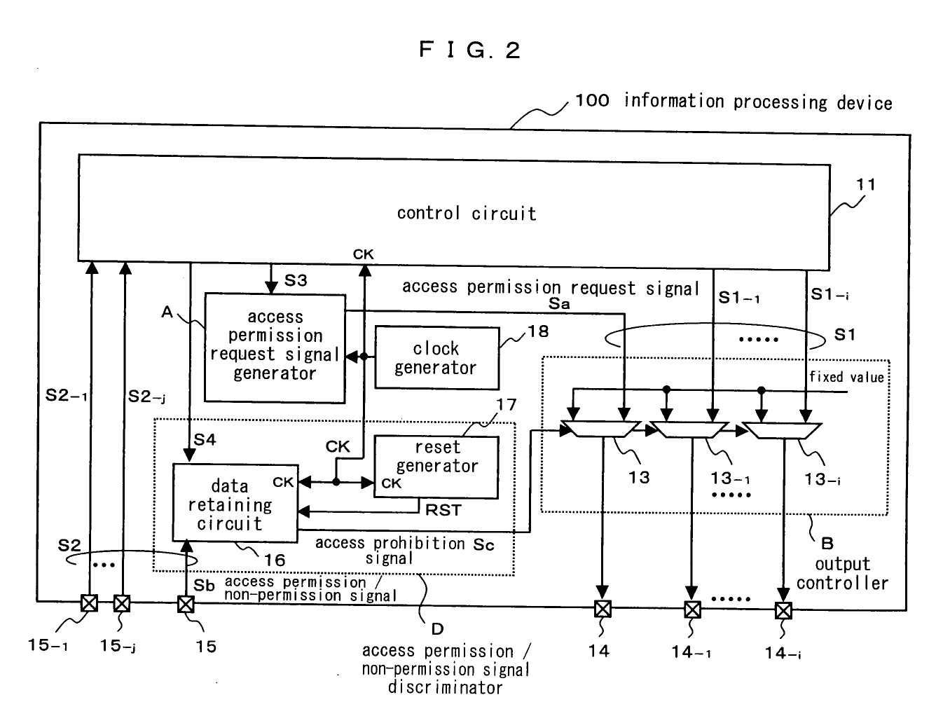

In FIG. 2, the constitution shown in FIG. 1 is more specifically developed. A reference numeral 11 shown in FIG. 2 denotes a control circuit. The control circuit 11 generates first communication signals S1₋₁-S1₋ᵢ outputted to the communication target device 400, and analyzes second communication signals S2₋₁-S2₋ⱼ inputted from the communication target device 400 to thereby generate a subsequent control signal and the like. A reference symbol A denotes the access permission request signal generator. A reference numeral 13 denotes a selector for selecting the access permission request signal Sa or a fixed value and outputting a result of the selection. Reference numerals 13₋₁-13₋ᵢ denote selectors for selecting the first communication signals S1₋₁-S1₋ᵢ or a fixed value and outputting a result of the selection. A reference numeral 14 denotes an output terminal for outputting the access permission request signal S1 or the fixed value. Reference numerals 14₋₁-14₋ᵢ denote output terminals for outputting the first communication signals S1₋₁-S1₋ᵢ or the fixed value. A reference numeral 15 denotes an input terminal to which the access permission/non-permission signal Sb is inputted. Reference numerals 15₋₁-15₋ⱼ denote input terminals to which the second communication signals S2₋₁-S2₋ⱼ are inputted. The group of second communication signals including the access permission/non-permission signal Sb and the second communication signals S2₋₁-S2₋ⱼ are outputted by the communication target device 400 and inputted to the information-processing device 100. A reference numeral 16 denotes a data retaining circuit for retaining the access permission/non-permission signal Sb inputted to the input terminal 15. A reference numeral 17 denotes a reset generator for generating a reset signal RST. A reference numeral 18 denotes a clock generator for generating a clock CK.

The first communication signals S1₋₁-S1₋ᵢ include test data and test clocks, and has a function for debugging the communication target device 400. The test data comprises addresses and data to be written in a register or a memory of the communication target device 400 for the debug. The second communication signals S2₋₁-S2₋ⱼ include lead data (trace information, data and the like) that is formed as a result by the access of the first communication signals S1₋₁-S1₋ᵢ.

The clock generator 18 generates the clock CK based on a defined cycle and supplies the generated clock to the control circuit 11, access permission request signal generator A, data retaining circuit 16 and reset generator 17. The information-processing device 100 operates in synchronization with the clock CK.

The control circuit 11 generates a generation instructing signal S3 which instructs the generation of the access permission request signal Sa and outputs the generated signal to the access permission request signal generator A. The control circuit 11 generates a reception enable signal S1₋₁. The reception enable signal S1₋₁ is outputted from the output terminal 14₋₁ to the communication target device 400 via the selector 13₋₁. The reception enable signal S1₋₁ is a signal which indicates whether or not the information-processing device 100 permits the reception of the access permission request signal Sa in the communication target device 400 as the first communication signal. The control circuit 11 generates a retention enable signal S4 that permits the retention of the access permission/non-permission signal Sb and outputs the generated signal to the data retaining circuit 16.

The access permission request signal generator A receives the generation instructing signal S3 from the control circuit 11 and correspondingly generates the access permission request signal Sa in accordance with the clock CK supplied from the clock generator 118. The access permission request signal Sa is outputted from the output terminal 14 to the communication target device 400 via the selector 13. The reset generator 17 generates the reset signal RST. The reset signal RST is outputted to the data retaining circuit 16.

Describing a correspondence relationship between FIGS. 1 and 2, the selector 13 and the selectors 13₋₁-13₋ᵢ correspond to the output controller B, and the data retaining circuit 16 and the reset generator 17 correspond to the access permission/non-permission signal discriminator D. In the present preferred embodiment, the output controller B corresponds to the communication controller. The output controller B blocks at least apart of the outputs of the group of first communication signals S1 in response to the generation of the access prohibition signal Sc.

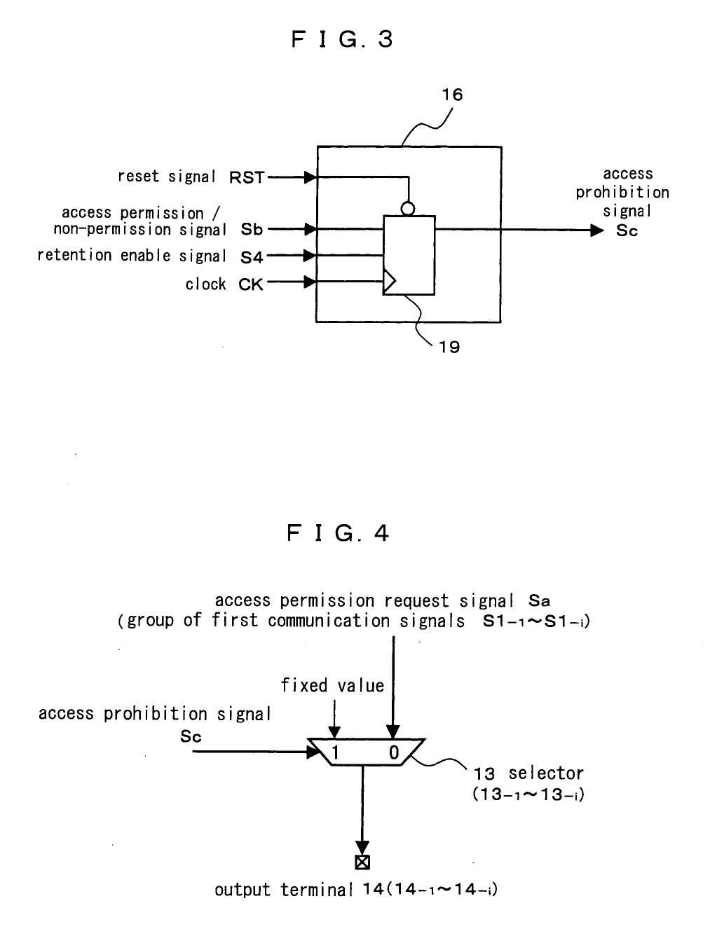

FIG. 3 shows a constitution of the data retaining circuit 16. The data retaining circuit 16 comprises a register 19. The clock CK supplied from the clock generator 18, the reset signal RST supplied from the reset generator 17, the retention enable signal S4 generated by the control circuit 11, and the access permission/non-permission signal Sb inputted from the input terminal 15 are inputted to the register 19.

The register 19 initializes the data to “0” when the reset signal RST is inputted thereto. The register 19 further retains the value of the access permission/non-permission signal Sb in accordance with the clock CK only when the retention enable signal S4 is effective, and outputs the retained value as the access prohibition signal Sc to the selectors 13 and 13₋₁-13₋ᵢ. The selectors 13 and 13₋₁-13₋ᵢ are switched to the selection side of the fixed value when the access prohibition signal Sc is inputted thereto to thereby prohibit the access to the communication target device 400.

FIG. 4 shows a constitution of the selectors 13 and 13₋₁-13₋ᵢ. The selector 13 selects the access permission request signal Sa when the access prohibition signal Sc is “0” and outputs it to the output terminal 14, while the selector 13 selects the fixed value when the access prohibition signal Sc is “1” and outputs it to the output terminal 14. In a similar manner, the selectors 13₋₁-S3₋ᵢ select the first communication signals S1₋₁-S1₋ᵢ generated by the control circuit 11 when the access prohibition signal Sc is “0” and output them to the output terminals 14₋₁-14₋ᵢ. The selectors 13₋₁-13₋ᵢ select the fixed value when the access prohibition signal Sc is “1” and output it to the output terminals 14₋₁-14₋ᵢ. When the fixed value is selected, the access to the communication target device 400 is substantively prohibited.

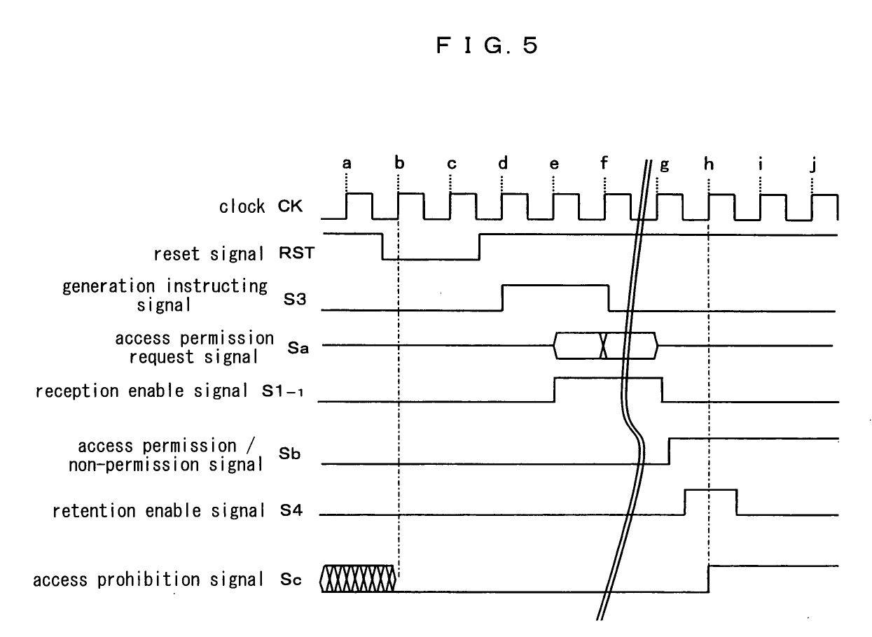

Next, an operation of the information-processing device 100 according to the present preferred embodiment thus constituted is described referring to a timing chart shown in FIG. 5 (a sequence from the generation of the access permission request signal Sa through the retention of the access permission non-permission signal Sb).

First, the reset generator 17 generates the reset signal RST at the time of initialization and outputs the generated reset signal to the data retaining circuit 16 (timings a-b). The data retaining circuit 16 outputs “0” as the access prohibition signal Sc to the selectors 13 and 13₋₁-13₋ᵢ in response to the input of the reset signal RST (timing b). Therefore, after the initialization, the selectors 13 and 13₋₁-13₋ᵢ select the access permission request signal Sa and the first communication signals S1₋₁-S1₋ᵢ and output the selected signals to the output terminals 14 and 14₋₁-14₋ᵢ. The communication signals S1₋₁-S1₋ᵢ are generated by the control circuit 11.

Next, the control circuit 11 outputs the generation instructing signal S3 to the access permission request signal generator A (timing d). The access permission request signal generator A receives the generating instructing signal S3 and correspondingly generates the access permission request signal Sa in accordance with the clock CK supplied from the clock generator 18 (timings e-g). The control circuit 11 further generates the reception enable signal S1₋₁ at the same timing as starting the generation of the access permission request signal Sa (timings e-g).

The access permission request signal Sa and the reception enable signal S1₋₁ are outputted from the output terminals 14 and 14₋₁ to the communication target device 400.

The communication target device 400 retrieves the access permission request signal Sa when the reception enable signal S11 is effective and authenticates the retrieved signal (timings e-g). The communication target device 400 outputs the value “0” as the access permission/non-permission signal Sb when the current access made by the information-processing device 100 is judged to be legitimate based on the authentication of the access permission request signal Sa, while outputting the value “1” as the access permission/non-permission signal Sb when the access is judged to be illegitimate (timing g). The access permission/non-permission signal Sb is inputted to the information-processing device 100 via the input terminal 15.

The control circuit 11 generates the retention enable signal S4 at the timing of the determination of the access permission/non-permission signal Sb and outputs the generated signal S4 to the data retaining circuit 16 (timings g-i). The data retaining circuit 16 retains the access permission/non-permission signal Sb when the retention enable signal S4 becomes effective (timing h).

When the received access permission/non-permission signal Sb shows “0” in consequence of the judgment of the current access made by the communication target device 400 as legitimate, the data retaining circuit 16 outputs “0” as the access prohibition signal Sc. Therefore, the selectors 13 and 13₋₁-13₋ᵢ select the access permission request signal Sa and the first communication signals S1₋₁-S1₋ᵢ outputted by the control circuit 11, and output the selected signals to the output terminals 14 and 14₋₁-14₋ᵢ. In the operation thereafter, the first communication signals S1₋₁-S1₋ᵢ generated by the control circuit 11 are supplied to the communication target device 400. As a result, the communication target device 400 is debugged.

When the received access permission/non-permission signal Sb shows “1” as a result that the current access made by the communication target device 400 is judged as unauthorized, the data retaining circuit 16 outputs “1” as the access prohibition signal Sc. Therefore, the selectors 13 and 13₋₁-13₋ᵢ select the fixed value and output it to the output terminals 14 and 14₋₁-14₋ᵢ. In the operation thereafter, the first communication signals S1₋₁-S1₋ᵢ and the access permission request signal Sa are masked and not supplied to the communication target device 400. As a result, the communication is blocked.

According to the constitution described above, when the access permission request signal Sa outputted from the information-processing device 100 to the information communication target device 400 is judged to be unauthorized by the information communication target device 400, the communication function of the information-processing device 100 itself is blocked. As a result, any unauthorized access thereafter is prevented.

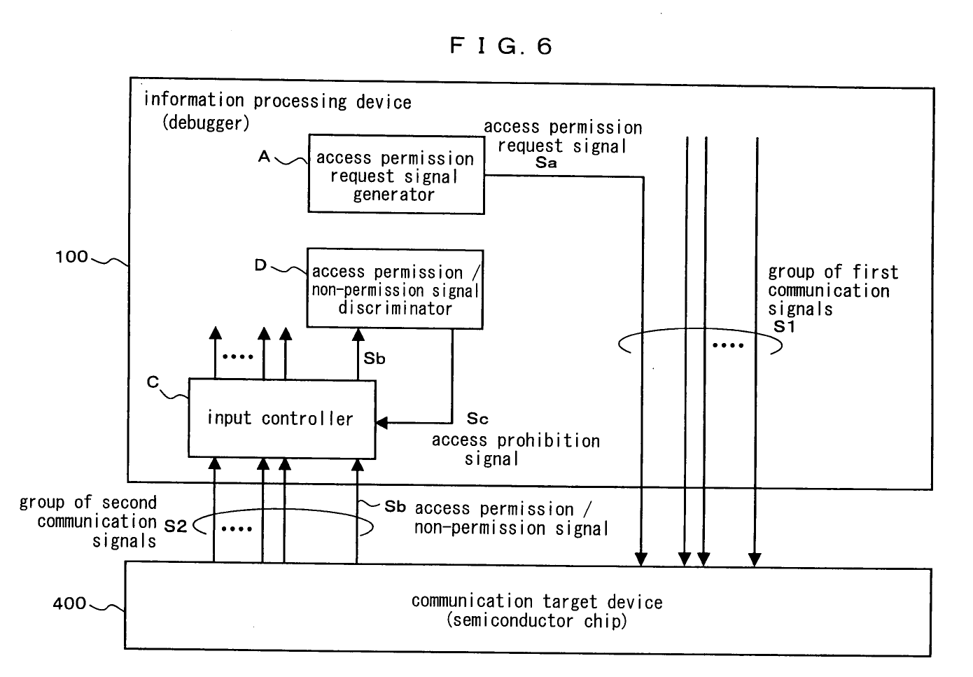

FIG. 6 is a block diagram illustrating a schematic constitution of an information-processing device according to a modified embodiment 1 of the preferred embodiment 1. In the constitution shown in FIG. 6, the output controller B is omitted, and an input controller C is provided in the constitution shown in FIG. 1. The input controller C controls the inputs of the group of second communication signals S2 including the access permission/non-permission signal Sb. More specifically, the input controller C blocks any or all of the inputs of the group of second communication signals S2 when the access prohibition signal Sc is inputted thereto. The access permission/non-permission signal discriminator D judges the access permission/non-permission signal Sb inputted from the input controller C and outputs the access prohibition signal Sc to the input controller C when the non-permission of the access is determined. The input controller C can be constituted in a manner similar to that of the output controller B shown in FIG. 2 (selector for selecting the fixed value). In the present modified embodiment, the input controller C corresponds to the communication controller. The input controller C blocks at least a part of the inputs of the group of second communication signals S2 in response to the generation of the access prohibition signal Sc.

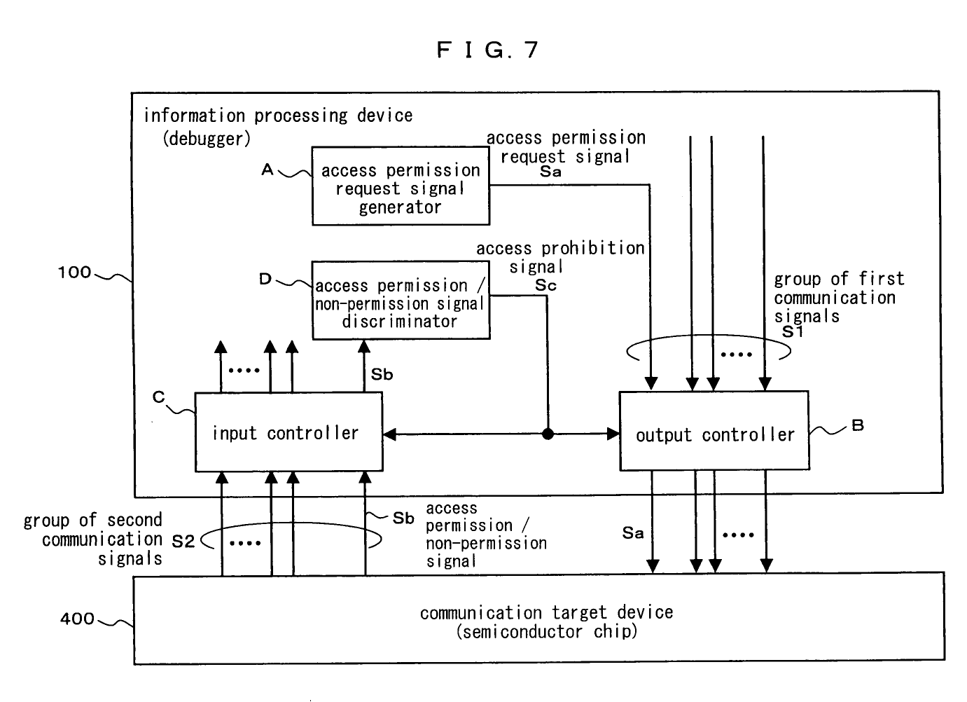

FIG. 7 is a block diagram illustrating a schematic constitution of an information-processing device according to a modified embodiment 2 of the preferred embodiment 1. In the constitution shown in FIG. 7, the input controller C is additionally provided in the constitution shown in FIG. 1. The constitution is different from that of FIG. 6, however, in that the output controller B is not omitted. The access permission/non-permission signal discriminator D discriminates the access permission/non-permission Sb inputted from the input controller C, and outputs the access prohibition signal Sc to the output controller B and the input controller C when the non-permission of the access is determined. In the present modified embodiment, the output controller B and the input controller C correspond to the communication controller. The output controller B blocks at least a part of the outputs of the group of first communication signals S1 in response to the generation of the access prohibition signal Sc. The input controller C blocks at least a part of the inputs of the group of second communication signals in response to the generation of the access prohibition signal Sc.

### Preferred Embodiment 2

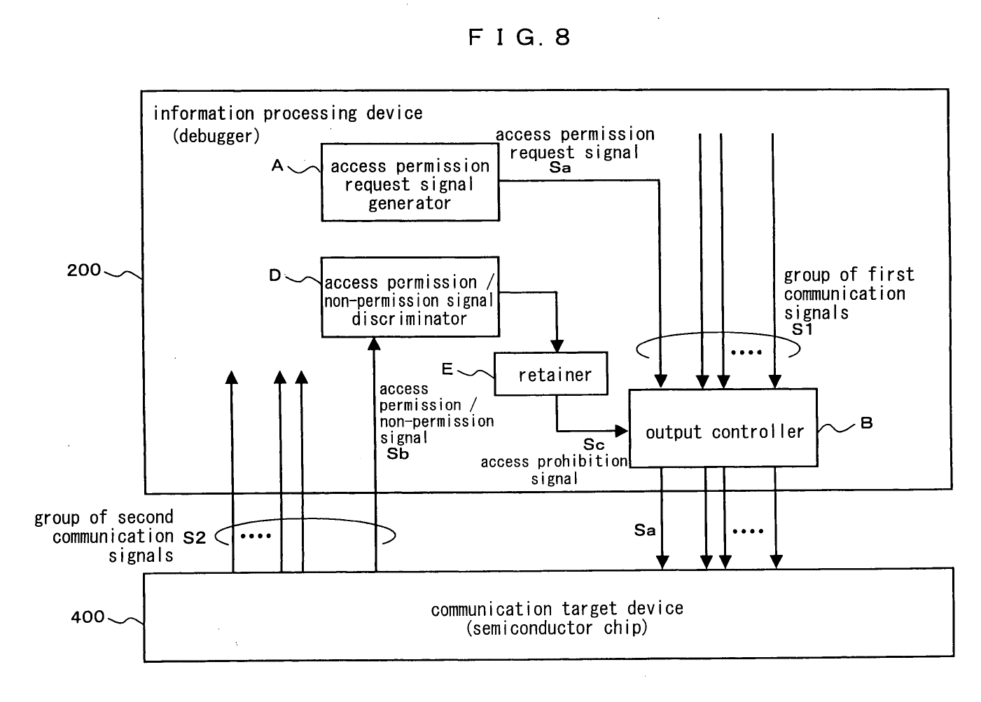

FIG. 8 is a block diagram illustrating a schematic constitution of an information-processing device according to a preferred embodiment 2 of the present invention. In FIG. 8, it is not described in detail as the same symbols in FIG. 1 denote the same component.

In an information-processing device 200 according to the present preferred embodiment, a retainer E is provided between the access permission/non-permission signal discriminator D and the output controller B. The retainer E permanently retains the access prohibition signal Sc in the access-prohibited state, that is outputted based on the judgment made by the access permission/non-permission signal discriminator D that the access permission/non-permission Sb indicates the non-permission of the access, and outputs the resulting signal.

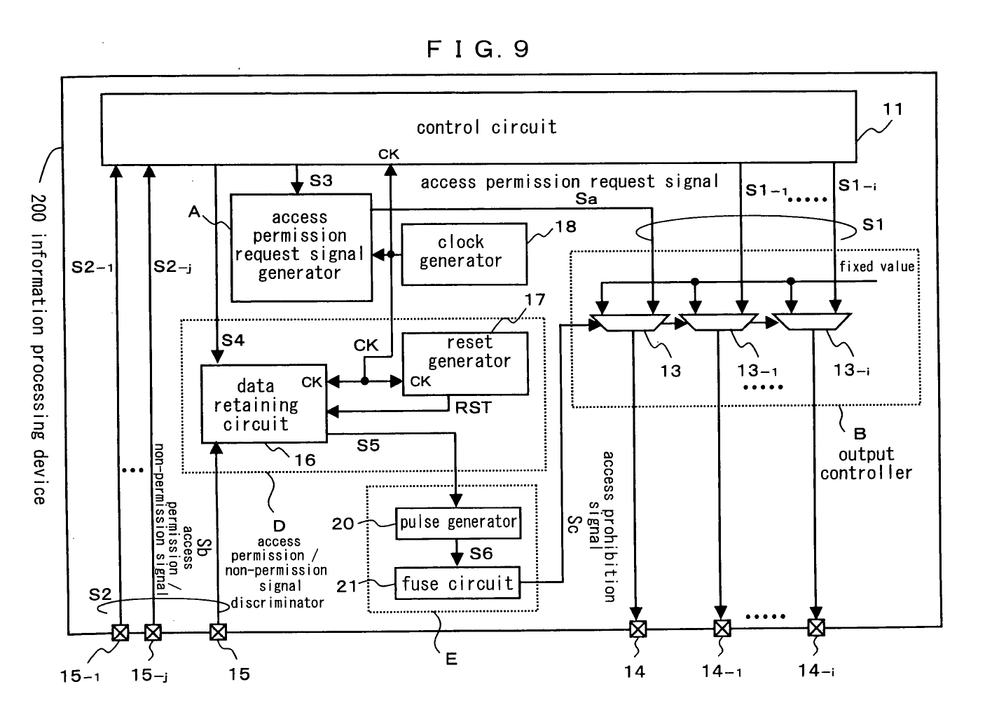

In FIG. 9, the constitution shown in FIG. 8 is more specifically developed. The information-processing device 200 further comprises a pulse generator 20 and a fuse circuit 21 in addition to the constitution according to the preferred embodiment 1 shown in FIG. 2. Describing a correspondence relationship between FIGS. 8 and 9, the pulse generator 20 and the fuse circuit 21 correspond to the retainer E.

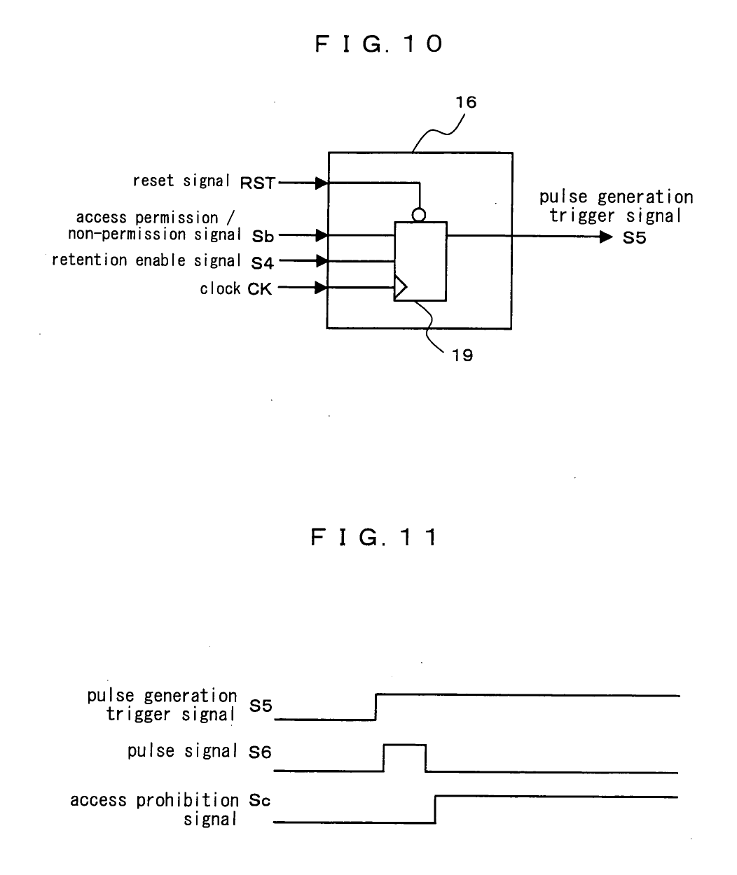

FIG. 10 shows a constitution of the data retaining circuit 16. The register 19 retains the value of the access permission/non-permission signal Sb in accordance with the clock CK only when the retention enable signal S4 is effective and outputs the retained value of the access permission/non-permission signal Sb as a pulse generation trigger signal S5 to the pulse generator 20. The pulse generator 20, when detecting a timing by which a rising edge of the pulse generation trigger signal S5 is shown (timing by which “0” is switched to “1”), generates a pulse signal S6 immediately after the detection and outputs the generated signal S6 to the fuse circuit 21. At any other timing, the pulse signal S6 is not generated. The fuse circuit 21 outputs the access prohibition signal Sc to the selectors 13 and 13₋₁-13₋ᵢ. In a normal operation in which the pulse signal S6 is not inputted, the fuse circuit 21 outputs “0” as the access prohibition signal. When the pulse signal S6 is inputted to the fuse circuit 21, the fuse circuit 21 switches the access prohibition signal Sc to “1”. Because the fuse circuit 21 has a fuse effect, the access prohibition signal Sc, which is once switched to “1”, is not thereafter switched back to “0”. FIG. 11 shows a relationship between the output of the pulse generator 20 and the output of the fuse circuit 21.

Next, an operation of the information-processing device 200 according to the present preferred embodiment thus constituted is described. First, the reset generator 17 generates the reset signal RST at the time of the initialization and outputs it to the data retaining circuit 16. The data retaining circuit 16 outputs “0” as the pulse generation trigger signal S5 to the pulse generator 20 when the reset signal RST is inputted thereto. In this state, the pulse generator 20 is not operated, therefore, does not output the pulse signal S6. Accordingly, the fuse circuit 21 is not operated either, and “0” is supplied as the access prohibition signal to the selectors 13 and 13₋₁-13₋ᵢ. Thereby, the selectors 13 and 13₋₁-13₋ᵢ, immediately after the initialization, select the access permission request signal Sa and the first communication signals S1₋₁-S1₋ᵢ generated by the control circuit 11, and output the selected signals to the communication target device 400 via the output terminals 14 and 14₋₁-14₋ᵢ.

A sequence from the generation of the access permission request signal Sa through the retention of the access permission/non-permission signal Sb is similar to that of the preferred embodiment 1 described referring to FIG. 5, therefore, is not described again here.

When the received access permission/non-permission signal Sb shows “0” in consequence of the judgment made by the communication target device 400 that the current access is an authorized access, the data retaining circuit 16 maintains “0” without change as the pulse generation trigger signal S5. Accordingly, the pulse generator 20 and the fuse circuit 21 are not operated, and the access prohibition signal Sc remains “0” without change. Therefore, the selectors 13 and 13₋₁-13₋ᵢ select the access permission request signal Sa and the first communication signals S1₋₁-S1₋ᵢ and output the selected signals to the communication target device 400 via the output terminals 14 and 14₋₁-14₋ᵢ. By doing so, in the operation thereafter, the operation of the communication target device 400 is analyzed by the first communication signals S1₋₁-S1₋ᵢ generated by the control circuit 11.

Meanwhile, when the received access permission/non-permission signal Sb shows “1” in consequence of the judgment made by the communication target device 400 that the current access is an unauthorized access, the data retaining circuit 16 outputs “1” as the pulse generation trigger signal S5 to the pulse generator 20. “1” is inputted to the pulse generator 20 as the pulse generation trigger signal S5, and the pulse generator 20 correspondingly detects the rising edge of pulse generation trigger signal S5. Then, the pulse generator 20 generates the pulse signal S6 and outputs the generated signal to the fuse circuit 21. In the fuse circuit 21, the output thereof is switched to “1” when the pulse signal S6 is detected. More specifically, the fuse circuit 21 outputs “1” to the selectors 13 and 13₋₁-13₋ᵢ as the access prohibition signal Sc. Therefore, the selectors 13 and 13₋₁-13₋ᵢ select the fixed value and output it to the communication target device 400 via the output terminals 14 and 14₋₁-14₋ᵢ. In the operation thereafter, the first communication signals S1₋₁-S1₋ᵢ generated by the control circuit 11 and the access permission request signal Sa generated by the access permission request signal generator A are blocked and not transmitted to the communication target device 400. As a result, the communication between the information-processing device and the communication target device is blocked. The output of the fuse circuit 21 thereafter is not switched to “0” and permanently fixed to “1”. Therefore, the communication is not made possible again by reset or the like.

When the communication target device 400 determines that the access permission request signal Sa outputted to the communication target device 400 is unauthorized according to the foregoing constitution, the communication function of the information-processing device 100 itself is permanently blocked, which prevents any unauthorized access made thereafter.

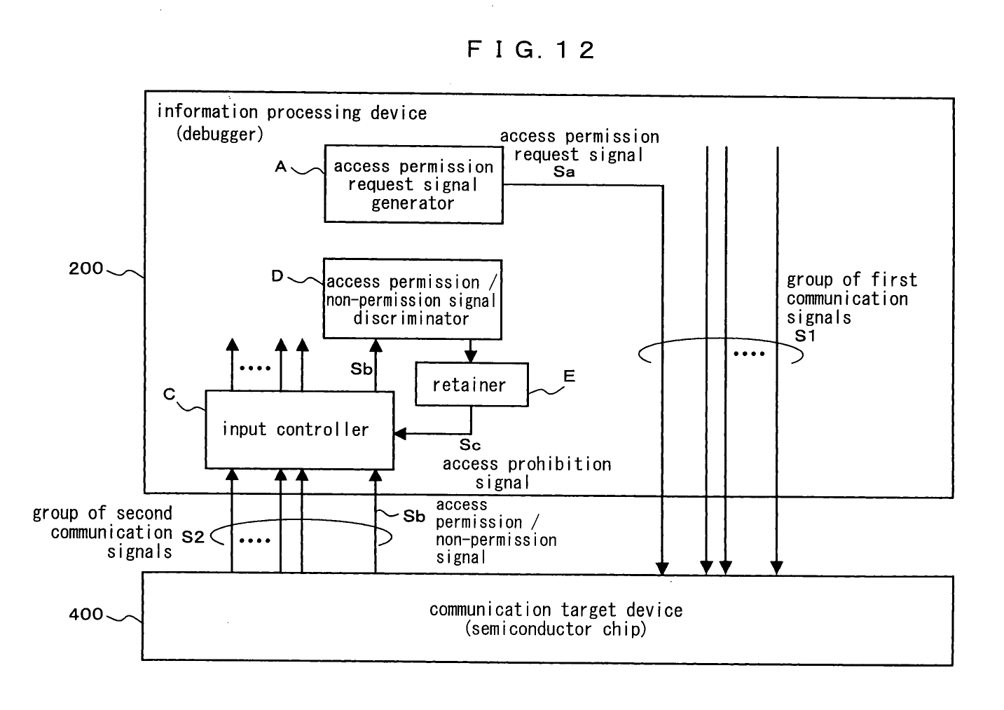

FIG. 12 is a block diagram illustrating a schematic constitution of an information-processing device according to a modified embodiment 1 of the preferred embodiment 2. In the constitution shown in FIG. 12, the output controller B is omitted, and the input controller C and the retainer E are alternatively provided in the constitution of FIG. 8. More specifically, the retainer E is provided between the access permission/non-permission signal discriminator D and the input controller C. The retainer E permanently maintains the access prohibition signal Sc in the access-prohibited state, which is outputted by the access permission/non-permission signal discriminator D based on the judgment that the access permission/non-permission signal Sb indicates the non-permission of the access, and outputs the resulting signal. In the present modified embodiment, the input controller C corresponds to the communication controller.

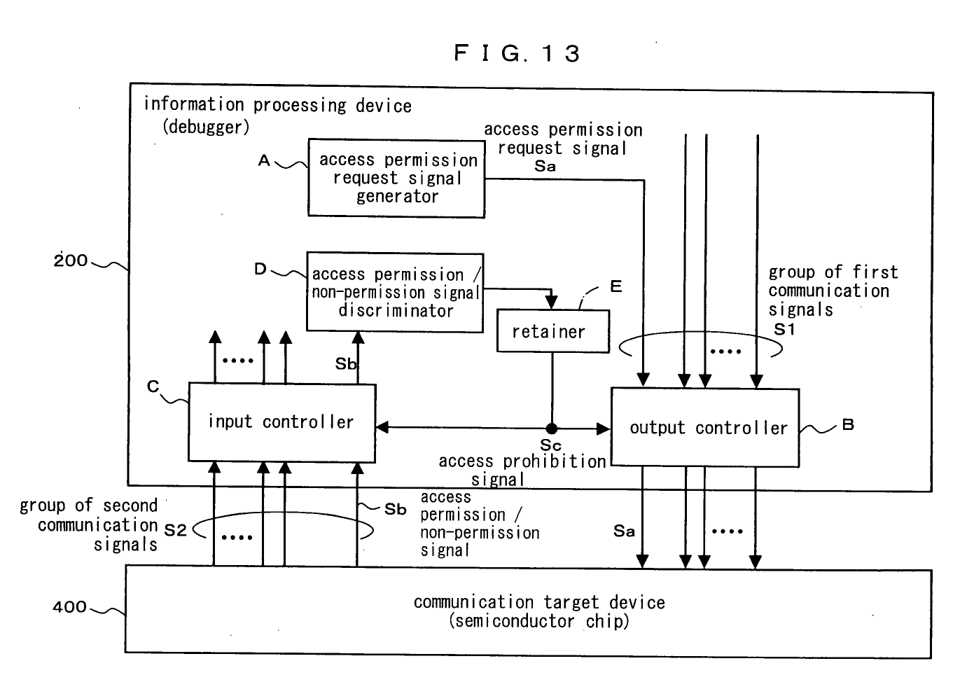

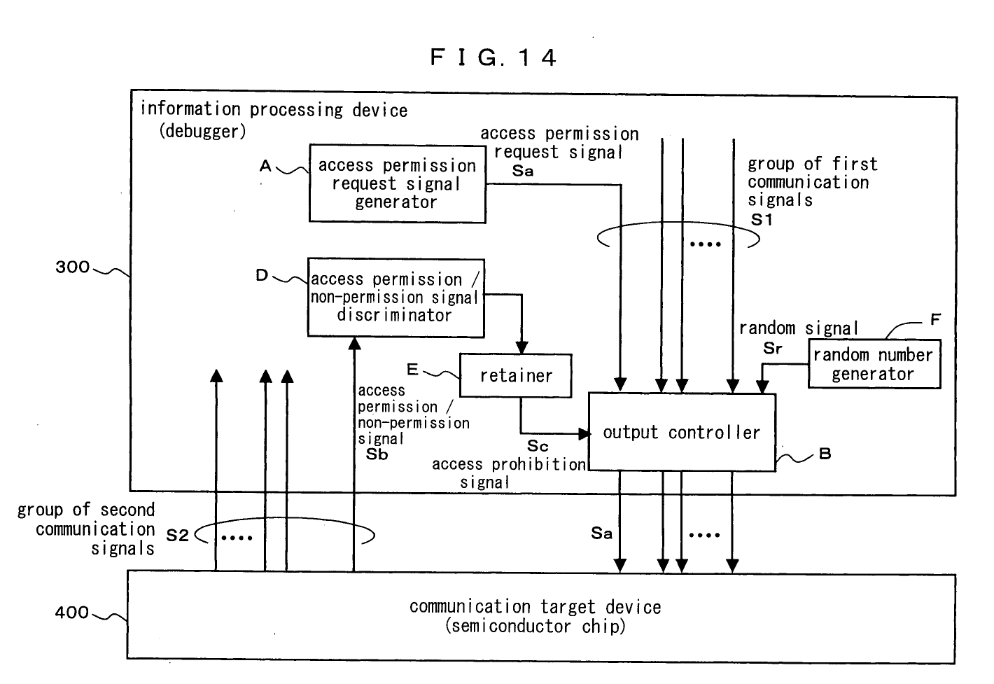

FIG. 13 is a block diagram illustrating a schematic constitution of an information-processing device according to a modified embodiment 2 of the preferred embodiment 2. In the constitution shown in FIG. 13, the input controller C is provided in the constitution of FIG. 8, and the output controller B is not omitted. The retainer E is provided between the access permission/non-permission signal discriminator D and the output controller B, and between the access permission/non-permission signal discriminator D and the input controller C. The retainer E permanently maintains the access prohibition signal Sc in the access-prohibited state, which is outputted by the access permission/non-permission signal discriminator D based on the judgment that the access permission/non-permission signal Sb indicates the non-permission of the access, and outputs the resulting signal. In the present modified embodiment, the output controller B and the input controller C correspond to the communication controller.

### Preferred Embodiment 3

FIG. 14 is a block diagram illustrating a schematic constitution of an information-processing device according to a preferred embodiment 3 of the present invention. It is not described in detail again as the same symbols in FIG. 8 of the preferred embodiment 2 denote the same component in FIG. 14.

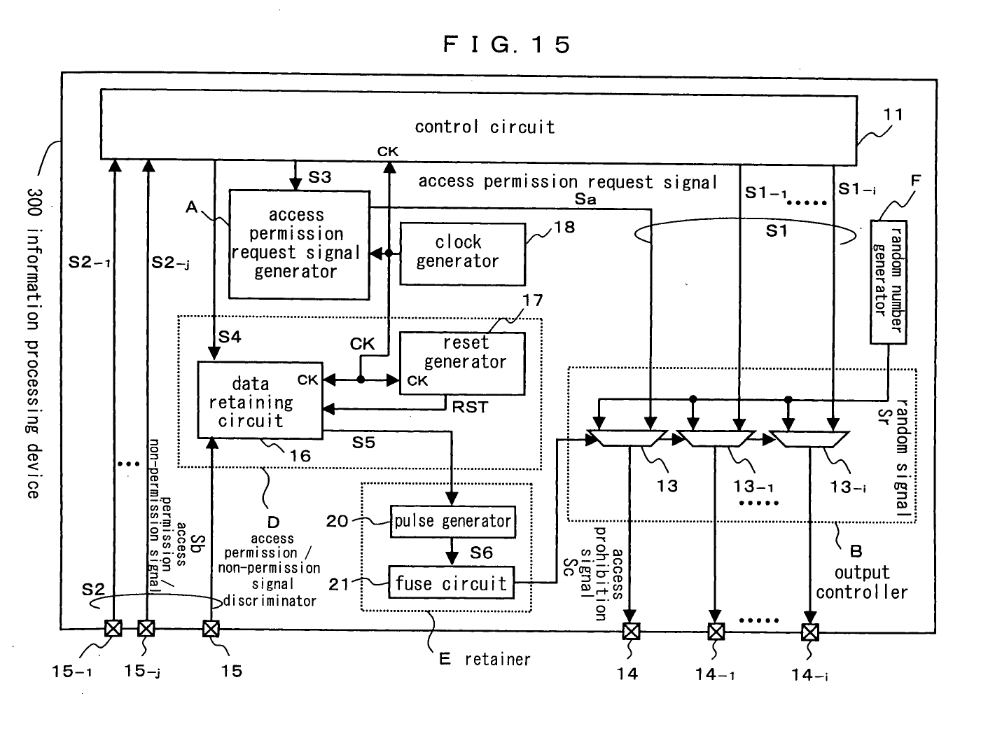

In an information-processing device 300 according to the present preferred embodiment, a random number generator F is provided on the input side of the output controller B. In FIG. 15, the constitution of FIG. 14 is more specifically developed. It is not described in detail again as the same symbols in FIG. 9 of the preferred embodiment 2 denote the same component in FIG. 15. In the information-processing device 300 according to the present preferred embodiment, a random signal Sr outputted from the random number generator F is inputted to the selectors 13 and 13₋₁-13₋ᵢ in place of the fixed value inputted to the selectors 13 and 13₋₁-13₋ᵢ.

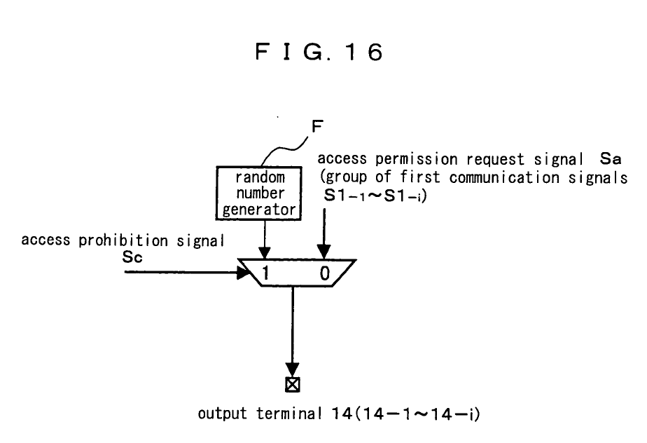

FIG. 16 shows a constitution of the selectors 13 and 13₋₁-13₋ᵢ. The selector 13 selects the access permission request signal Sa when the access prohibition signal Sc is “0” and outputs the selected signal to the output terminal 14, while the selector 13 selects the random signal Sr when the access prohibition signal Sc is “1” and outputs the selected signal to the output terminal 14. In a similar manner, the selectors 13₋₁-13₋ᵢ select the first communication signals S1₋₁-S1₋ᵢ generated by the control circuit 11 when the access prohibition 10 signal Sc is “0” and output the selected signals to the output terminals 14₋₁-14₋ᵢ, while the selector 13 selects the random signal Sr when the access prohibition signal Sc is “1” and outputs the selected signal to the output terminals 14₋₁-14₋ᵢ.

Next, an operation of the information-processing device 300 according to the present preferred embodiment thus constituted is described. When the current access is judged to be an unauthorized access by the communication target device 400 and the received access permission/non-permission signal Sb consequently shows “1”, the fuse circuit 21 outputs “1” as the access prohibition signal Sc to the selectors 13 and 13₋₁-13₋ᵢ in a manner similar to the foregoing description. The selectors 13 and 13₋₁-13₋ᵢ select the random signal Sr outputted by the random number generator F and output the selected signal to the communication target device 400 via the output terminals 14 and 14₋₁-14₋ᵢ. By doing so, in the operation thereafter, the first communication signals S1₋₁-S1₋ᵢ generated by the control circuit 11 and the access permission request signal Sa generated by the access permission request signal generator A are blocked and not transmitted to the communication target device 400. As a result, the communication is blocked.

According to the constitution so far described, depending on a result wherein the communication target device 400 has determined that the current access is authorized based on the access permission request signal Sa outputted by the information-processing device 300, and the access permission/non-permission signal Sb received by the information-processing device 300 consequently shows “0”, the output signal of the information-processing device 300 is permanently replaced with the random signal Sr outputted by the random number generator F, so that any unauthorized access thereafter made can be prevented. Further, the variable output signal makes it difficult to identify the cause of the communication failure, which improves the security performance.

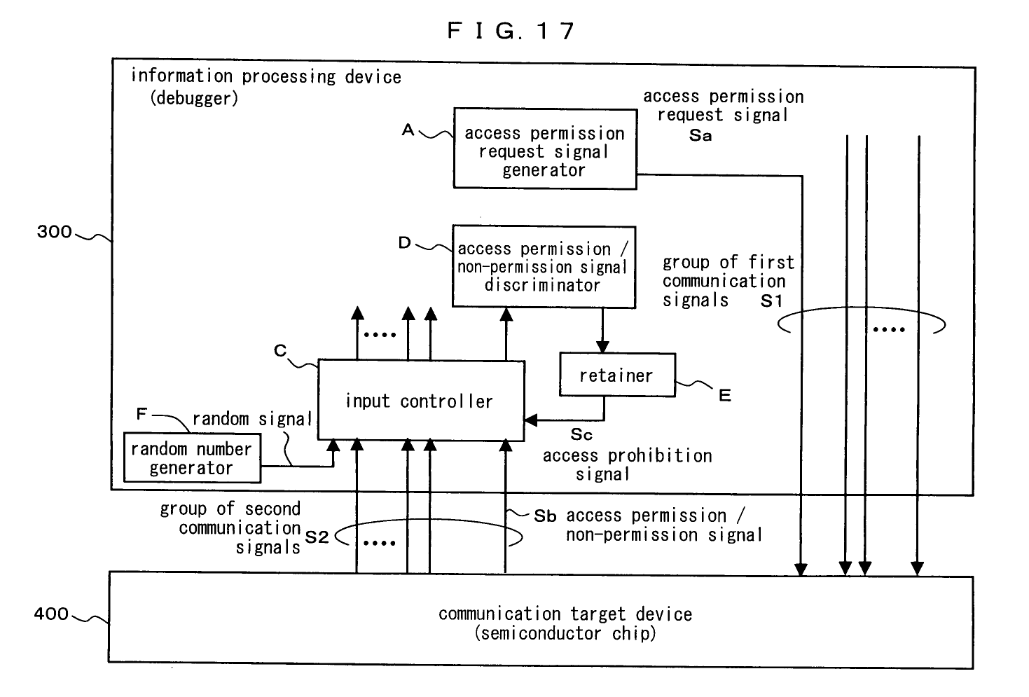

FIG. 17 is a block diagram illustrating a schematic constitution of an information-processing device according to a modified embodiment 1 of the preferred embodiment 3. In the constitution shown in FIG. 17, the output controller B is replaced with the input controller C in the constitution of FIG. 14. The random number generator F is provided on the input side of the input controller C. In the present modified embodiment, the input controller C corresponds to the communication controller.

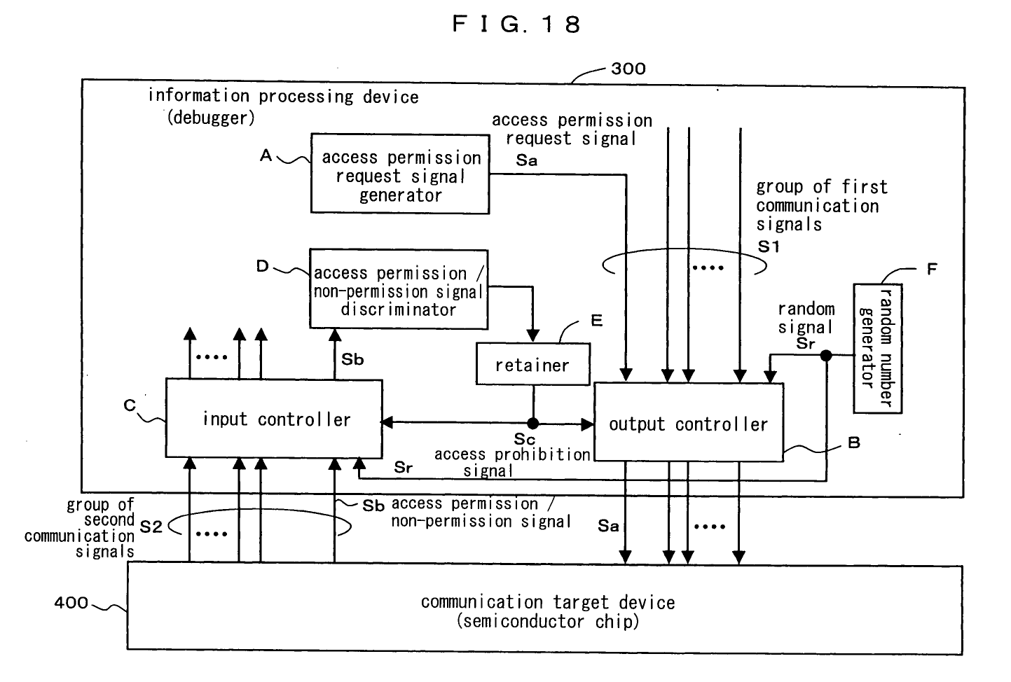

FIG. 18 is a block diagram illustrating a schematic constitution of an information-processing device according to a modified embodiment 2 of the preferred embodiment 3. The random number generator F is provided on the input side of the output controller B and the input controller C. In the present modified embodiment, the output controller B and the input controller C correspond to the communication controller.

The technology according to the present preferred embodiment may be applied to the preferred embodiment 1 in which the retainer E is not provided.

The basic embodiments of the present invention were described so far. The present invention can be further implemented in the following manner.

The information-processing device according to the present preferred embodiment was described as the debugger of the communication target device 400, however, the function thereof is not limited thereto.

In the foregoing description, the access permission request signal generator A is provided separately from the control circuit 11, however, may alternatively generate the access permission request signal Sa as one of the functions of the control circuit 11.

In the foregoing description, the clock generator 18 is provided so that the clock CK is supplied to each circuit. The clock may be alternatively supplied to each circuit from a clock generator provided outside via a clock input terminal.

In the foregoing description, the reset generator 17 is provided so that the reset signal RST is generated inside. The reset signal RST may be alternatively supplied from a reset generator provided outside via a reset input terminal.

In the foregoing description, the pulse generator 20 generates the pulse by the rising edge, but the operation thereof is not necessarily limited thereto.

In the foregoing description, the fuse circuit 21 switches the output from “0” to “1” by the input of the pulse, however, the operation thereof is not necessarily limited thereto.

In the foregoing description, the fuse circuit 21 is used in the embodiments as the retainer E for permanently blocking the communication. Such a component as a one-time ROM may be used to realize the function of the retainer E.

In the foregoing description, the selector is provided with respect to the access permission request signal Sa so that the retransmission of the access permission request signal Sa from the information-processing device to the communication target device 400 is prohibited when the access is not permitted by the communication target device 400. A counter, or the like, may control the transmission in such a manner that the access permission request signal Sa is transmitted a plurality of times.

The output terminal for the access permission request signal Sa and the output terminals for the first communication signals S1 are separately provided, however, these signals may be outputted via one terminal.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An information-processing device for communicating with an external communication target device comprising:
an access permission request signal generator for generating an access permission request signal which requests the communication target device to permit an access, and outputting the generated signal to the communication target device;
an access permission/non-permission signal discriminator for discriminating an access permission/non-permission signal outputted by the communication target device which received the access permission request signal, and generating an access prohibition signal when the access permission/non-permission signal shows the non-permission of the access; and
a communication controller for restricting at least a part of the communication in response to the generation of the access prohibition signal.

2. The information-processing device according to claim 1, wherein
the communication controller controls outputs of a group of first communication signals outputted by the information-processing device to the communication target device including the access permission request signal, and
the communication controller blocks at least a part of the outputs of the group of first communication signals in response to the generation of the access prohibition signal.

3. The information-processing device according to claim 1, wherein
the communication controller controls inputs of a group of second communication signals inputted by the communication target device to the information-processing device including the access permission/non-permission signal, and
the communication controller blocks at least a part of the inputs of the group of second communication signals in response to the generation of the access prohibition signal.

4. The information-processing device according to claim 1, wherein
the communication controller controls outputs of a group of first communication signals from the information-processing device including the access permission request signal, and also controls inputs of a group of second communication signals to the information-processing device including the access permission/non-permission signal, and
the communication controller blocks at least a part of the outputs of the group of first communication signals, and also blocks at least a part of the inputs of the group of second communication signals in response to the generation of the access prohibition signal.

5. The information-processing device according to claim 1, wherein
the access permission/non-permission signal discriminator comprises a register for retaining a value of the access permission/non-permission signal.

6. The information-processing device according to claim 1, further having a retainer for permanently retaining the access prohibition signal when the access permission/non-permission signal discriminator generates the access prohibition signal and maintaining an output of the access prohibition signal.

7. The information-processing device according to claim 2, further retaining a random number generator for generating a random signal, wherein
the communication controller outputs the random signal generated by the random number generator from the information-processing device as the group of first communication signals in place of the group of first communication signals in response to the generation of the access prohibition signal.

8. The information-processing device according to claim 3, further comprises a random number generator for generating a random signal, wherein
the communication controller inputs the random signal generated by the random number generator to the information-processing device as the group of second communication signals in place of the group of second communication signals in response to the generation of the access prohibition signal.

9. The information-processing device according to claim 4, further comprises a random number generator for generating a random signal, wherein
the communication controller inputs the random signal generated by the random number generator to the information-processing device as the group of second communication signals in place of the group of second communication signals, and also outputs the random signal generated by the random number generator from the information-processing device as the group of first communication signals in place of the group of first communication signals in response to the generation of the access prohibition signal.

10. The information-processing device according to claim 4, wherein
the group of first communication signals include an address and data necessary for debugging the communication target device, and
the group of second communication signals include a trace information and data outputted by the communication target device.

11. An information-processing system comprising the information-processing device and the communication target device according to claim 1, wherein
the communication target device puts the access permission/non-permission signal into a state of access permission and outputs the resulting signal to the information-processing device when the access permission request signal inputted from the information-processing device is judged to be legitimate, and puts the access permission/non-permission signal into a state of access refusal and outputs the resulting signal to the information-processing device when the access permission request signal is judged to be illegitimate.
